(19) United States
(12) Patent Application Publication
(10) Pub. No.: US 2021/0362719 A1
(43) Pub. Date: Nov. 25, 2021

(54) ARBITRATING FRICTION AND REGENERATIVE BRAKING FOR AUTONOMOUS VEHICLES

(71) Applicant: WAYMO LLC, Mountain View, CA (US)

(72) Inventor: Nolan McPeek-Bechtold, Belmont, CA (US)

(21) Appl. No.: 16/924,416

(22) Filed: Jul. 9, 2020

Related U.S. Application Data
(60) Provisional application No. 63/026,822, filed on May 19, 2020.

(51) Int. Cl. B60W 30/18; G05D 1/02; B60W 10/184; B60L 7/18; B60L 7/26

(52) U.S. Cl. CPC B60W 30/18127; G05D 1/0223; B60W 2510/18; B60L 7/18; B60L 7/26; B60W 10/184

(57) ABSTRACT

Aspects of the disclosure provide for a method of controlling a vehicle in an autonomous driving mode. For instance, the method may include receiving, by one or more processors of a brake controller of the vehicle, a braking profile for a trajectory for the vehicle to follow into the future. The brake controller may determine whether to use one or both of regenerative and friction braking based on the braking profile. The vehicle is controlled according to the braking profile based on the determination of whether to use one or both of regenerative and friction braking.

### CROSS REFERENCE TO RELATED APPLICATIONS

The present application claims the benefit of the filing date of U.S. Provisional Application No. 63/026,822, filed May 19, 2020, the entire disclosure of which is incorporated by reference herein.

### BACKGROUND

Autonomous vehicles, for instance, vehicles that do not require a human driver, can be used to aid in the transport of passengers or items from one location to another. Such vehicles may operate in a fully autonomous mode where passengers may provide some initial input, such as a pickup or destination location, and the vehicle maneuvers itself to that location. Autonomous vehicles are equipped with various types of sensors in order to detect objects in the surroundings. For example, autonomous vehicles may include sonar, radar, camera, LIDAR, and other devices that scan and record data from the vehicle's surroundings. This data can be used to localize the vehicle relative to pre-stored map information.

Many vehicles with an electric motor are capable of building negative torque in order to slow down the vehicle with either or both the electric motor via regenerative braking and by using conventional friction brakes. For a given brake command, brake controllers need to determine how much of the braking torque should be accomplished by the electric motor and how much should be accomplished by the friction brakes. In making this decision, the brake controller may weigh competing factors like the different noise levels generated by both forms of braking, the different performance levels available from both forms of braking, the energy efficiency impact of using regenerative braking and the vehicle component wear from using friction braking.

### BRIEF DESCRIPTION OF THE DRAWINGS

FIG. 1 is a functional diagram of an example vehicle in accordance with an exemplary embodiment.

FIG. 2 is an example block diagram of aspects of a vehicle in accordance with aspects of the disclosure.

FIG. 3 is an example diagram of a vehicle in accordance with aspects of the disclosure.

FIG. 4 is an example braking profile in accordance with aspects of the disclosure.

FIG. 5 is an example braking profile in accordance with aspects of the disclosure.

FIG. 6 is an example braking profile in accordance with aspects of the disclosure.

FIG. 7 is an example braking profile in accordance with aspects of the disclosure.

FIG. 8 is an example flow diagram in accordance with aspects of the disclosure.

### SUMMARY

Aspects of the disclosure provide a method of controlling a vehicle in an autonomous driving mode. The method includes receiving, by one or more processors of a brake controller of the vehicle, a braking profile for a trajectory for the vehicle to follow into the future; determining, by the brake controller, whether to use one or both of regenerative and friction braking based on the braking profile; and controlling, by the brake controller, deceleration of the vehicle according to the braking profile based on the determination of whether to use one or both of regenerative and friction braking.

In on example, determining whether to use one or both of regenerative and friction braking is further based on a magnitude of deceleration of the braking profile. In another example, determining whether to use one or both of regenerative and friction braking is further based on a rate of change of deceleration of the braking profile. In another example, the method also includes receiving information identifying an object associated with the braking profile, wherein determining whether to use one or both of regenerative and friction braking is further based on the identified object. In this example, the method also includes determining whether the braking profile is for a safety critical driving situation based on the identified object, and wherein determining whether to use one or both of regenerative and friction braking is further based on the determination of whether the braking profile is for a safety critical driving situation. In another example, the braking profile extends at least 1 second into the future.

Another aspect of the disclosure provides a system for controlling a vehicle in an autonomous driving mode. The system includes one or more processors of a brake controller configured to: receive a braking profile for a trajectory for the vehicle to follow into the future; determine whether to use one or both of regenerative and friction braking based on the braking profile; and control deceleration of the vehicle according to the braking profile based on the determination of whether to use one or both of regenerative and friction braking.

In this example, the one or more processors are further configured to determine whether to use one or both of regenerative and friction braking further based on a magnitude of deceleration of the braking profile. In another example, the one or more processors are further configured to determine whether to use one or both of regenerative and friction braking further based on a rate of change of deceleration of the braking profile. In another example, the one or more processors are further configured to determine receiving information identifying an object associated with the braking profile, and to determine whether to use one or both of regenerative and friction braking further based on the identified object. In this example, the one or more processors are further configured to determine whether the braking profile is for a safety critical driving situation based on the identified object, and determining whether to use one or both of regenerative and friction braking is further based on the determination of whether the braking profile is for a safety critical driving situation. In another example, the braking profile extends at least 1 second into the future. In another example, the system also includes the vehicle.

Another aspect of the disclosure provides a non-transitory recording medium on which instructions are stored. The instructions when executed by one or more processors, cause the one or more processors to perform a method of controlling a vehicle in an autonomous driving mode. The method includes receiving, by one or more processors of a brake controller of the vehicle, a braking profile for a trajectory for the vehicle to follow into the future; determining, by the brake controller, whether to use one or both of regenerative and friction braking based on the braking profile; and controlling, by the brake controller, deceleration of the vehicle according to the braking profile based on the determination of whether to use one or both of regenerative and friction braking.

In one example, determining whether to use one or both of regenerative and friction braking is further based on a magnitude of deceleration of the braking profile. In another example, determining whether to use one or both of regenerative and friction braking is further based on a rate of change of deceleration of the braking profile. In another example, the method further comprises receiving information identifying an object associated with the braking profile, wherein determining whether to use one or both of regenerative and friction braking is further based on the identified object. In another example, the method further comprises determining whether the braking profile is for a safety critical driving situation based on the identified object, and wherein determining whether to use one or both of regenerative and friction braking is further based on the determination of whether the braking profile is for a safety critical driving situation. In another example, the braking profile extends at least 1 second into the future.

### DETAILED DESCRIPTION

### Overview

The technology relates to regenerative braking schemes for autonomous vehicles. As noted above, many vehicles with an electric motor are capable of building negative torque in order to slow down the vehicle with either or both the electric motor via regenerative braking and by using conventional friction brakes. For a given brake command, brake controllers need to determine how much of the braking torque should be accomplished by the electric motor and how much should be accomplished by the friction brakes. In making this decision, the brake controller may weigh competing factors like the different noise levels generated by both forms of braking, the different performance levels available from both forms of braking, the energy efficiency impact of using regenerative braking and the vehicle component wear from using friction braking.

In general, regenerative braking may be quieter, improves energy efficiency, and allows the friction brake components to last longer as compared to friction braking. Of course, friction braking may result in shorter stopping distances. In addition, conventional brake controllers may typically utilize friction braking for safety critical events such as with advanced driver assistance systems which automatically apply the brakes to avoid a collision with another object.

Despite all this, because drivers control the brakes by pressing on a single brake pedal, in a conventional system, the brake controller only knows the current and past brake commands when attempting to determine whether to engage regenerative braking. For instance, a human driver is only able to engage friction braking, but it is up to the brake controller to determine whether the vehicle can switch to regenerative braking. In addition brake controllers of such vehicles are only able to make determinations about whether to use friction or regenerative braking based on the current inputs to a brake pedal of the vehicle by the driver. This results in an imperfect allocation of friction and regenerative braking which results in increased brake wear and decreased efficiency.

Autonomous vehicles may generate trajectories many seconds into the future and can easily issue more than one kind of brake command. These trajectories include the desired vehicle acceleration and the desired rate of change of acceleration at different points in time in the future. In this regard, the brake controller knows not only the past and current braking commands, the brake controller also knows future braking commands.

Based on the current and future acceleration command and or the current and future acceleration rate of change commands, an autonomous vehicle's brake controller can determine the appropriate mix of electric motor or regenerative braking and friction braking. The brake controller is able to perform this kind of brake type arbitration because it can maintain more than one brake interface and the brake controller can determine whether to engage regenerative or friction braking based on what the brake controller will do at some point in the future.

For instance, the vehicle's planning system may generate a trajectory for the vehicle to follow including a braking profile. The brake controller may determine what type of braking is best suited for each portion of the braking profile. This may be based on both the magnitude of the braking in the braking profile as well as the rate of change of the braking in the braking profile.

The vehicle's planning system may generate the aforementioned trajectories based on classified objects and road features. This information can be leveraged by the brake controller, for instance to determine if that deceleration is safety critical. This is possible because the brake controller can maintain more than one brake interface, and the brake controller knows what objects and road features to which the vehicle is responding to when the planning system builds a deceleration profile. Thus, the brake controller is able to manage the regenerative braking in a way which promotes safety of the vehicle, its occupants as well as other road users and objects external to the vehicle.

The features described herein may provide for an improved allocation of friction and regenerative braking for autonomous vehicles as compared to conventional braking systems. This, in turn, may result in decreased brake wear, increased efficiency of the vehicle (as there is greater regenerative braking) while at the same time maintaining safe operation of the vehicle, as well as other improvements.

### Example Systems

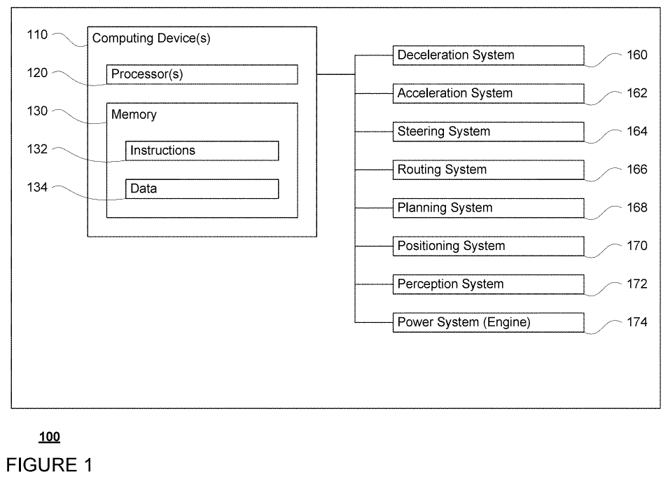

As shown in FIG. 1, a vehicle 100 in accordance with one aspect of the disclosure includes various components. While certain aspects of the disclosure are particularly useful in connection with specific types of vehicles, the vehicle may be any type of vehicle including, but not limited to, cars, trucks, motorcycles, buses, recreational vehicles, etc. The vehicle may have one or more computing devices, such as computing device 110 containing one or more processors 120, memory 130 and other components typically present in general purpose computing devices.

The memory 130 stores information accessible by the one or more processors 120, including instructions 132 and data 134 that may be executed or otherwise used by the processor 120. The memory 130 may be of any type capable of storing information accessible by the processor, including a non-transitory recording medium which can be read by computing devices or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 132 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

The data 134 may be retrieved, stored or modified by processor 120 in accordance with the instructions 132. For instance, although the claimed subject matter is not limited by any particular data structure, the data may be stored in computing device registers, in a relational database as a table having a plurality of different fields and records, XML documents or flat files. The data may also be formatted in any computing device-readable format.

The one or more processor 120 may be any conventional processors, such as commercially available CPUs or GPUs. Alternatively, the one or more processors may be a dedicated device such as an ASIC or other hardware-based processor. Although FIG. 1 functionally illustrates the processor, memory, and other elements of computing device 110 as being within the same block, it will be understood by those of ordinary skill in the art that the processor, computing device, or memory may actually include multiple processors, computing devices, or memories that may or may not be stored within the same physical housing. For example, memory may be a hard drive or other storage media located in a housing different from that of computing device 110. Accordingly, references to a processor or computing device will be understood to include references to a collection of processors or computing devices or memories that may or may not operate in parallel.

The computing devices 110 may also be connected to one or more speakers as well as one or more user inputs. The speakers may enable the computing devices to provide audible messages and information, such as the alerts described herein, to occupants of the vehicle, including a driver. In some instances, the computing devices may be connected to one or more vibration devices configured to vibrate based on a signal from the computing devices in order to provide haptic feedback to the driver and/or any other occupants of the vehicle. As an example, a vibration device may consist of a vibration motor or one or more linear resonant actuators placed either below or behind one or more occupants of the vehicle, such as embedded into one or more seats of the vehicle.

The user input may include a button, touchscreen, or other devices that may enable an occupant of the vehicle, such as a driver, to provide input to the computing devices 110 as described herein. As an example, the button or an option on the touchscreen may be specifically designed to cause a transition from the autonomous driving mode to the manual driving mode or the semi-autonomous driving mode.

In one aspect the computing devices 110 may be part of an autonomous control system capable of communicating with various components of the vehicle in order to control the vehicle in an autonomous driving mode. For example, returning to FIG. 1, the computing devices 110 may be in communication with various systems of vehicle 100, such as deceleration system 160, acceleration system 162, steering system 164, routing system 166, planning system 168, positioning system 170, and perception system 172 in order to control the movement, speed, etc. of vehicle 100 in accordance with the instructions 132 of memory 130 in the autonomous driving mode. In this regard, each of these systems may be one or more processors, memory, data and instructions. Such processors, memories, instructions and data may be configured similarly to one or more processors 120, memory 130, instructions 132, and data 134 of computing device 110.

As an example, computing devices 110 may interact with deceleration system 160 and acceleration system 162 in order to control the speed of the vehicle. Similarly, steering system 164 may be used by computing devices 110 in order to control the direction of vehicle 100. For example, if vehicle 100 is configured for use on a road, such as a car or truck, the steering system may include components to control the angle of wheels to turn the vehicle.

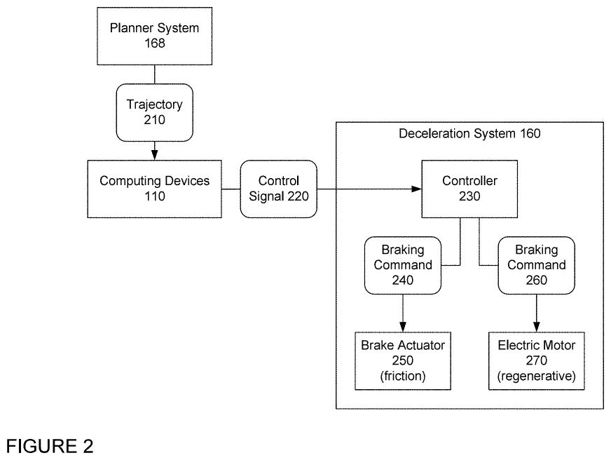

The deceleration system 160 may include a brake controller and a brake actuator which may function to control the vehicle's brakes. For instance, as depicted in the example of FIG. 2, the planning system 168 may generate a trajectory 210 as discussed further below. The computing device 110 may extract a braking profile or the portion of that trajectory which requires the vehicle to decelerate. In other words, the computing devices 110 may determine current and future acceleration commands and/or the current and future acceleration rate of change commands. The computing devices 110 may then send a control signal 220 including the braking profile to a controller of the deceleration system 160.

The brake controller 230 may be a computing device that includes processors and memory configured the same as or similarly to processors 120 and memory 130. The brake controller 230 may use the braking profile of the control signal 220 to send a braking command 240 to a brake actuator 250 of the vehicle, for example, in order to engage the vehicle's brakes using conventional friction braking and cause the vehicle to decelerate in accordance with the braking command 240. The brake controller may use the braking profile of the control signal 220 to send a braking command 260 to one or more electric motors of a regenerative braking system 270 in order to engage regenerative braking. For example, in known, conventional regenerative braking systems, an electric motor may convert the kinetic energy of the vehicle into potential energy. This energy may then be stored, for example, in one or more batteries or other chemical reactions, in one or more capacitors, in a rotating flywheel, as compressed air, etc. This recovery of energy, in turn, may cause the vehicle to decelerate in accordance with the braking command 260. Of course, deceleration of the vehicle from regenerative braking may not be able to achieve the amounts of deceleration and rates of deceleration as friction braking. Moreover, regenerative braking may not be as dynamic, that is the rate of braking may not be changed quickly, and due to the additional complexity of regenerative braking, it is often not considered high reliability or high integrity. Thus, regenerative braking may not be practical or desirable for safety critical stoppings.

Planning system 168 may be used by computing devices 110 in order to determine and follow a route generated by a routing system 166 to a location. For instance, the routing system 166 may use pre-stored map information to determine a route from a current location of the vehicle to a destination location. The planning system 168 may periodically generate trajectories, or short-term plans for controlling the vehicle for some period of time into the future, in order to follow the route (a current route of the vehicle) to the destination. In this regard, the planning system 168, routing system 166, and/or data 134 may store detailed map information, e.g., highly detailed maps identifying the shape and elevation of roadways, lane lines, intersections, crosswalks, speed limits, traffic signals, buildings, signs, real time traffic information, vegetation, or other such objects and information. In addition, the map information may identify area types such as constructions zones, school zones, residential areas, parking lots, etc.

The map information may include one or more roadgraphs or graph networks of information such as roads, lanes, intersections, and the connections between these features which may be represented by road segments. Each feature may be stored as graph data and may be associated with information such as a geographic location and whether or not it is linked to other related features, for example, a stop sign may be linked to a road and an intersection, etc. In some examples, the associated data may include grid-based indices of a roadgraph to allow for efficient lookup of certain roadgraph features.

The map information may be an image-based map or need not be entirely image based (for example, raster). For example, the map information may include one or more roadgraphs or graph networks of information such as roads, lanes, intersections, and the connections between these features which may be represented by road segments. Each feature may be stored as graph data and may be associated with information such as a geographic location and whether or not it is linked to other related features, for example, a stop sign may be linked to a road and an intersection, etc. In some examples, the associated data may include grid-based indices of a roadgraph to allow for efficient lookup of certain roadgraph features.

Positioning system 170 may be used by computing devices 110 in order to determine the vehicle's relative or absolute position on a map and/or on the earth. The positioning system 170 may also include a GPS receiver to determine the device's latitude, longitude and/or altitude position relative to the Earth. Other location systems such as laser-based localization systems, inertial-aided GPS, or camera-based localization may also be used to identify the location of the vehicle. The location of the vehicle may include an absolute geographical location, such as latitude, longitude, and altitude as well as relative location information, such as location relative to other cars immediately around it which can often be determined with less noise than absolute geographical location.

The positioning system 170 may also include other devices in communication with the computing devices of the computing devices 110, such as an accelerometer, gyroscope or another direction/speed detection device to determine the direction and speed of the vehicle or changes thereto. By way of example only, an acceleration device may determine its pitch, yaw or roll (or changes thereto) relative to the direction of gravity or a plane perpendicular thereto. The device may also track increases or decreases in speed and the direction of such changes. The device's provision of location and orientation data as set forth herein may be provided automatically to the computing device 110, other computing devices and combinations of the foregoing.

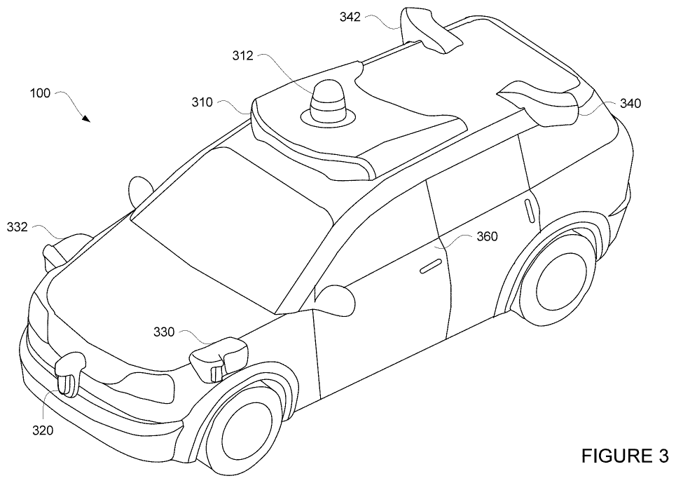

The perception system 172 also includes one or more components for detecting objects external to the vehicle such as other vehicles, obstacles in the roadway, traffic signals, signs, trees, etc. For example, the perception system 172 may include lasers, sonar, radar, cameras and/or any other detection devices that record data which may be processed by the computing devices of the computing devices 110. In the case where the vehicle is a passenger vehicle such as a minivan, the minivan may include a laser or other sensors mounted on the roof or other convenient location. For instance, FIG. 3 is an example external view of vehicle 100. In this example, roof-top housing 310 and dome housing 312 may include a LIDAR sensor as well as various cameras and radar units. In addition, housing 320 located at the front end of vehicle 100 and housings 330, 332 on the driver's and passenger's sides of the vehicle may each store a LIDAR sensor. For example, housing 330 is located in front of driver door 360. Vehicle 100 also includes housings 340, 342 for radar units and/or cameras also located on the roof of vehicle 100. Additional radar units and cameras (not shown) may be located at the front and rear ends of vehicle 100 and/or on other positions along the roof or roof-top housing 310.

The computing devices 110 may be capable of communicating with various components of the vehicle in order to control the movement of vehicle 100 according to primary vehicle control code of memory of the computing devices 110. For example, returning to FIG. 1, the computing devices 110 may include various computing devices in communication with various systems of vehicle 100, such as deceleration system 160, acceleration system 162, steering system 164, routing system 166, planning system 168, positioning system 170, perception system 172, and power system 174 (i.e. the vehicle's engine or motor) in order to control the movement, speed, etc. of vehicle 100 in accordance with the instructions 132 of memory 130.

The various systems of the vehicle may function using autonomous vehicle control software in order to determine how to and to control the vehicle. As an example, a perception system software module of the perception system 172 may use sensor data generated by one or more sensors of an autonomous vehicle, such as cameras, LIDAR sensors, radar units, sonar units, etc., to detect and identify objects and their features. These features may include location, type, heading, orientation, speed, acceleration, change in acceleration, size, shape, etc. In some instances, features may be input into a behavior prediction system software module which uses various behavior models based on object type to output a predicted future behavior for a detected object.

In other instances, the features may be put into one or more detection system software modules, such as a traffic light detection system software module configured to detect the states of known traffic signals, a school bus detection system software module configured to detect school busses, construction zone detection system software module configured to detect construction zones, a detection system software module configured to detect one or more persons (e.g. pedestrians) directing traffic, a traffic accident detection system software module configured to detect a traffic accident, an emergency vehicle detection system configured to detect emergency vehicles, etc. Each of these detection system software modules may input sensor data generated by the perception system 172 and/or one or more sensors (and in some instances, map information for an area around the vehicle) into various models which may output a likelihood of a certain traffic light state, a likelihood of an object being a school bus, an area of a construction zone, a likelihood of an object being a person directing traffic, an area of a traffic accident, a likelihood of an object being an emergency vehicle, etc., respectively.

Detected objects, predicted future behaviors, various likelihoods from detection system software modules, the map information identifying the vehicle's environment, position information from the positioning system 170 identifying the location and orientation of the vehicle, a destination for the vehicle as well as feedback from various other systems of the vehicle may be input into a planning system software module of the planning system 168. The planning system may use this input to generate trajectories for the vehicle to follow for some brief period of time into the future based on a current route of the vehicle generated by a routing module of the routing system 166. A control system software module of the computing devices 110 may be configured to control movement of the vehicle, for instance by controlling braking, acceleration and steering of the vehicle, in order to follow a trajectory as discussed above with regard to FIG. 2.

### Example Methods

In addition to the operations described above and illustrated in the figures, various operations will now be described. It should be understood that the following operations do not have to be performed in the precise order described below. Rather, various steps can be handled in a different order or simultaneously, and steps may also be added or omitted.

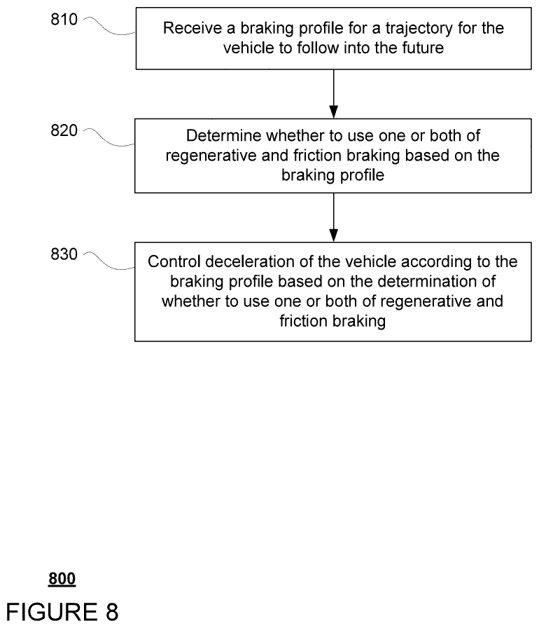

FIG. 8 includes an example flow diagram 800 of some of the examples for localizing a vehicle, such as vehicle 100, which may be performed by one or more processors such as processors of computing devices 110 and/or the processors of the brake controller 230. For instance, at block 810, a braking profile for a trajectory for the vehicle to follow into the future is received. As noted above, the planning system 168 may use various inputs in order to generate a trajectory for the vehicle to follow into the future. Each trajectory may include a geometry component identifying a shape of a desired path the vehicle should follow and a speed component identifying the desired speeds and accelerations at which the vehicle should travel into the future. In this regard, the trajectory may define how the vehicle should be controlled, for example, at least several seconds or more or less into the future. In some instances, the trajectory may include a first part for controlling the vehicle towards a destination location over the next second or so into the future and a second part for controlling the vehicle to safely stop if no new trajectories are received in time.

The speed component may be used by the computing devices 110 in order to determine a braking profile for controlling the vehicle's brakes in order to decelerate the vehicle in accordance with the trajectory. In this regard, the braking profile may also extend at least one or several seconds or more or less into the future. Therefore, the braking profile may extend into the future for a period of time that is significantly longer than any delays between the input of a human driver at a brake pedal of the vehicle and when a brake controller acts upon that input in conventional systems.

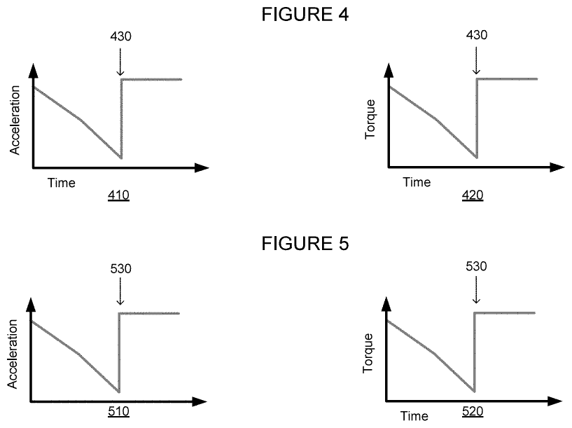

The braking profile may define the amount of deceleration (negative acceleration) of a given point in time in the future, and the slope of a braking profile may define the rate of change of deceleration (negative acceleration) and torque between any two points in time. For reference, FIG. 4 provides an example braking profile for stopping the vehicle, such as vehicle 100, in an empty area where there are no nearby road users detected by the perception system 172. In this example, the braking profile is depicted as the change in acceleration 410 and the change in torque 420 over time. The time depicted in this example is a future time, that is, this is a braking profile that the vehicle will follow at some point into the future which is not dependent upon a current input from a brake pedal (or accelerator) of a vehicle from a human driver. As shown in the example of FIG. 4, the amount of deceleration increases until the vehicle is stopped, at point 430 where the deceleration and acceleration go to zero. These braking profiles may be incorporated into the control signal 220 which is sent to and received by the brake controller 230 of the deceleration system 160.

At block 820, whether to use one or both of regenerative and friction braking is determined based on the braking profile. The brake controller 230 may determine what type of braking is best suited for each portion of the braking profile. In this regard, the “portion” may refer to each part of the braking profile where the slope of the acceleration or torque changes. In addition or alternatively, these portions may be determined using thresholds since the braking profiles may not all be linear lines but continuous curves. For example, if the rate of change of deceleration, deceleration or torque exceeded a threshold at any point in the braking profile, this may correspond to a transition from regenerative to friction braking. Similarly, for any portion corresponding to safety critical, this may correspond to a transition from regenerative to friction braking (or maintaining friction braking as the case may be).

This may be based on both the magnitude of the braking in each portion of the braking profile (e.g. the amount of deceleration) as well as the rate of change of the braking in each portion of the braking profile (e.g. the rate of change of deceleration).

For example, for harder braking events which require greater deceleration, greater torque, or a greater rate of change of deceleration, friction braking may be used. Similarly, for softer braking events which require less deceleration, less torque, or a lesser rate of change of deceleration, regenerative braking may be used. Of course the exact rates of deceleration, torque values, and rates of change of deceleration which may be appropriate for friction braking or regenerative braking will be dependent upon the implementation of the regenerative braking system 270. In other words, some regenerative braking systems may enable greater rates of deceleration and changes in rates of deceleration.

For example, for a vehicle configured similarly to vehicle 100, rates of change of deceleration of no more than 4 m/s3 may be appropriate for regenerative braking, while rates of change of deceleration of greater than 4 m/s3 may be appropriate for friction braking. In this example, deceleration of no more than 4 m/s2 may be appropriate for regenerative braking while deceleration of more than 4 m/s2 may be appropriate for friction braking. In addition, rates of change of torque of no more than 4000 Nm/s may be appropriate for regenerative braking, while rates of change or torque greater than 4000 Nm/s may be appropriate for friction braking. Further, torque of no more than 4000 Nm may be appropriate for regenerative braking, while torque greater than 4000 Nm may be appropriate for friction braking. Of course, other values may also be used as appropriate.

The brake controller is able to perform this kind of brake type arbitration because it can maintain more than one brake interface (e.g. both friction and electric motor) and the brake controller can determine whether to engage friction or regenerative braking based on what the brake controller will do at some point in the future.

As noted above, the planning system 168 may generate the aforementioned trajectories based on classified objects and road features. When each trajectory is published or made available to other systems of the vehicle, the planning system also identifies one or more objects to which the vehicle is responding when following the trajectory. This information may be provided to the brake controller directly from the planning system 168 or may be incorporated into the control signal 220 or another signal sent by the computing devices 110 to the brake controller 230. In addition, the brake controller may also have access to the map information used by the planning system. As such, the brake controller may also know why the vehicle is decelerating.

This information can be leveraged by the brake controller 230, for instance to determine if a particular braking profile or portion of the braking profile is safety critical or for a safety critical driving situation. If so, even where the magnitude and command rate of change of the braking profile would be suitable for regenerative braking, the brake controller would select friction braking. In other words, the brake controller can choose how to arbitrate between friction and regenerative braking based on how safety critical a given braking profile or driving situation is. For instance, the brake controller could arbitrate friction and regenerative braking based on a table for objects. For example, situations including humans, vehicles, railroad crossings, etc. may be considered safety critical driving situations whenever they are nearby to the vehicle 100, but stop signs and stop lights may not be considered safety critical driving situations.

FIGS. 4-7 provide examples of braking profiles and determinations by the brake controller. Again, for each of these examples, the time depicted in this example is a future time, that is, this is a braking profile that the vehicle will follow at some point into the future which is not dependent upon a current input from a brake pedal (or accelerator) of a vehicle from a human driver. As noted above, FIG. 4 provides an example braking profile for stopping the vehicle in an empty area.

FIG. 5 provides an example braking profile for stopping the vehicle for a child in a crosswalk. The child and crosswalk may be detected and identified by the perception system 172 and provided to the brake controller 230 as described above. In addition or alternatively, the brake controller may access the map information used by the planner system to identify that the child is located in the crosswalk. In this example, the braking profile is depicted as the change in acceleration 510 and the change in torque 520 over time. As shown in the example of FIG. 5, the amount of deceleration increases until the vehicle is stopped, at point 530 where the deceleration and acceleration go to zero.

While the braking profiles of the examples of FIGS. 4 and 5 are identical, the brake controller may treat these braking profiles very differently. For instance, the example braking profile of FIG. 4 is not safety critical or for a safety critical driving situation, so regenerative braking can be used by the brake controller 230. However, in the example of FIG. 5, the brake controller 230 may determine that the child in the crosswalks makes the braking profile or the driving situation safety critical, for example, by referring to the aforementioned table. As such, only friction braking will be used by the brake controller 230.

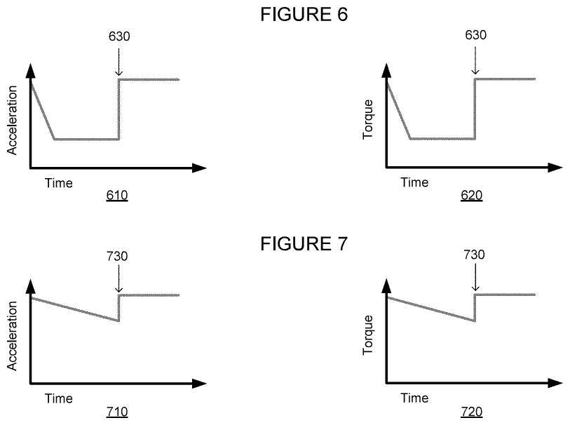

FIG. 6 provides an example braking profile for stopping the vehicle for a person walking in front of the vehicle. The person and his or her location may be detected and identified by the perception system 172 and provided to the brake controller 230 as described above. In this example, the braking profile is depicted as the change in acceleration 610 and the change in torque 620 over time. As shown in the example of FIG. 6, the amount of deceleration increases until the vehicle is stopped, at point 630 where the deceleration and acceleration go to zero. In this example, the brake controller 230 may determine that the person located in front of the vehicle makes the braking profile or the situation safety critical, for example, by referring to the aforementioned table. Thus, given the high rate of deceleration, torque and rate of deceleration required for the braking profile as well as the safety critical nature of the braking profile or driving situation, the brake controller may use only friction braking for this example.

FIG. 7 provides an example braking profile for pulling over a vehicle in order to stop to pick up a passenger. In this example, the braking profile is depicted as the change in acceleration 710 and the change in torque 720 over time. As shown in the example of FIG. 7, the amount of deceleration increases until the vehicle is stopped, at point 730 where the deceleration and acceleration go to zero. In this example, the brake controller 230 may determine that the braking profile or driving situation is not safety critical, for example, by referring to the aforementioned table. In addition, given the modest amount of deceleration and torque required, the brake controller 230 may use regenerative braking.

Returning to FIG. 8 at block 830, deceleration of the vehicle is controlled according to the braking profile based on the determination of whether to use one or both of regenerative and friction braking. Based on the types of braking determined for the different portions of the braking profile, the brake controller 230 may determine current and future acceleration or deceleration commands and/or the current and future acceleration or deceleration rate of change commands. Based on the current and future acceleration command and or the current and future acceleration rate of change commands, an autonomous vehicle's brake controller can determine the appropriate mix of electric motor and friction braking. The brake controller may use the braking profile of the control signal 220 to send a braking command 230 to a brake actuator 240 of the vehicle, for example, in order to engage the vehicle's brakes in order to engage friction braking and cause the vehicle to decelerate in accordance with the braking profile. The brake controller may use the braking profile of the control signal 220 to send a braking command 250 to one or more electric motors of a regenerative braking system 260 in order to engage regenerative braking.

The features described herein may provide for an improved allocation of friction and regenerative braking for autonomous vehicles as compared to conventional braking systems. This, in turn, may result in decreased brake wear, increased efficiency of the vehicle (as there is greater regenerative braking as compared to a system that relies on a human driver) while at the same time maintaining safe operation of the vehicle, as well as other improvements.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method of controlling a vehicle in an autonomous driving mode, the method comprising:
receiving, by one or more processors of a brake controller of the vehicle, a braking profile for a trajectory for the vehicle to follow into the future;
determining, by the brake controller, whether to use one or both of regenerative and friction braking based on the braking profile; and
controlling, by the brake controller, deceleration of the vehicle according to the braking profile based on the determination of whether to use one or both of regenerative and friction braking.

2. The method of claim 1, wherein determining whether to use one or both of regenerative and friction braking is further based on a magnitude of deceleration of the braking profile.

3. The method of claim 1, wherein determining whether to use one or both of regenerative and friction braking is further based on a rate of change of deceleration of the braking profile.

4. The method of claim 1, further comprising receiving information identifying an object associated with the braking profile, wherein determining whether to use one or both of regenerative and friction braking is further based on the identified object.

5. The method of claim 4, further comprising, determining whether the braking profile is for a safety critical driving situation based on the identified object, and wherein determining whether to use one or both of regenerative and friction braking is further based on the determination of whether the braking profile is for a safety critical driving situation.

6. The method of claim 1, wherein the braking profile extends at least 1 second into the future.

7. A system for controlling a vehicle in an autonomous driving mode, the system comprising:
one or more processors of a brake controller configured to:
receive a braking profile for a trajectory for the vehicle to follow into the future;
determine whether to use one or both of regenerative and friction braking based on the braking profile; and
control deceleration of the vehicle according to the braking profile based on the determination of whether to use one or both of regenerative and friction braking.

8. The system of claim 7, wherein the one or more processors are further configured to determine whether to use one or both of regenerative and friction braking further based on a magnitude of deceleration of the braking profile.

9. The system of claim 7, wherein the one or more processors are further configured to determine whether to use one or both of regenerative and friction braking further based on a rate of change of deceleration of the braking profile.

10. The system of claim 7, wherein the one or more processors are further configured to determine receiving information identifying an object associated with the braking profile, and to determine whether to use one or both of regenerative and friction braking further based on the identified object.

11. The system of claim 10, wherein the one or more processors are further configured to determine whether the braking profile is for a safety critical driving situation based on the identified object, and wherein determining whether to use one or both of regenerative and friction braking is further based on the determination of whether the braking profile is for a safety critical driving situation.

12. The system of claim 7, wherein the braking profile extends at least 1 second into the future.

13. The system of claim 7, further comprising the vehicle.

14. A non-transitory recording medium on which instructions are stored, the instructions when executed by one or more processors, cause the one or more processors to perform a method of controlling a vehicle in an autonomous driving mode, the method comprising:
receiving, by one or more processors of a brake controller of the vehicle, a braking profile for a trajectory for the vehicle to follow into the future;
determining, by the brake controller, whether to use one or both of regenerative and friction braking based on the braking profile; and
controlling, by the brake controller, deceleration of the vehicle according to the braking profile based on the determination of whether to use one or both of regenerative and friction braking.

15. The medium of claim 14, wherein determining whether to use one or both of regenerative and friction braking is further based on a magnitude of deceleration of the braking profile.

16. The medium of claim 14, wherein determining whether to use one or both of regenerative and friction braking is further based on a rate of change of deceleration of the braking profile.

17. The medium of claim 14, wherein the method further comprises receiving information identifying an object associated with the braking profile, wherein determining whether to use one or both of regenerative and friction braking is further based on the identified object.

18. The medium of claim 17, wherein the method further comprises determining whether the braking profile is for a safety critical driving situation based on the identified object, and wherein determining whether to use one or both of regenerative and friction braking is further based on the determination of whether the braking profile is for a safety critical driving situation.

19. The medium of claim 14, wherein the braking profile extends at least 1 second into the future.
